(19) United States
(12) Patent Application Publication
(10) Pub. No.: US 2006/0114171 A1
(43) Pub. Date: Jun. 1, 2006

(54) Windowed immersive environment for virtual reality simulators

(75) Inventors: Gian Vascotto, Thedford (CA); Mary E. Withers, London (CA); Rebecca McKillican, Toronto (CA); Niall Murray, London (CA)

Correspondence Address: ANISSIMOFF & ASSOCIATES;RICHMOND NORTH OFFICE CENTRE, SUITE 201, 235 NORTH CENTRE RD., LONDON, ON, N5X 4E7, CA

(73) Assignee: National Research Council of Canada

(21) Appl. No.: 10/986,324

(22) Filed: Nov. 12, 2004

(51) Int. Cl. G09G 5/00

(52) U.S. Cl. 345/1.1

(57) ABSTRACT

A windowed immersive environment, particularly for use in training simulations provides a high degree of visual fidelity and realistic depth of vision at appropriate distances at a reasonable cost. The environment integrates physical components with virtual components to create a realistic visual environment. In one embodiment, a frame delineates a simulation space and a plurality of back-projection display screens mounted in the frame defines windows in the realistic visual environment. The world outside the windows is generated as 3D stereo images projected on to the screens to provide 3D virtual views. One or more frame elements define one or more non-windowed parts of the visual environment perceptually integrated with one or more of the 3D virtual views to provide the realistic visual environment.

### FIELD OF THE INVENTION

The present invention is related to virtual reality simulators, particularly to simulation of vehicle operations.

### BACKGROUND OF THE INVENTION

Virtual reality (VR) simulations are increasingly popular for training operators on the use of various kinds of equipment. VR simulators permit training while freeing real equipment for their intended use, and permit training in a safer environment where mistakes by the trainee will not result in damage to equipment, a training site or people at the training site. VR potentially offers a lower cost training alternative than real-life on-the-job training. VR has been particularly exploited in training operators of vehicles, for example, aircraft (e.g. airplanes, helicopters), motor vehicles (e.g. cars, trucks) and construction equipment (e.g. cranes).

In the prior art, simulation systems can be roughly divided into three main categories: non-stereo systems, stereo-based personal systems, and projected immersive virtual reality systems.

Non-stereo systems are the most widely used. All non-stereo systems need to generate models and simulations through a computer or video recording. A computer then sends images to a projected or non-projected viewing environment. A degree of realism is obtained by having individuals sit in physical mockups of control environments in front of large, front or rear-projected screens. The sheer size of these screens offers a perspective and illusion of depth. The screens are typically set at a relatively long distance away from the user and away from the physical mockup, and may be viewed directly through windows in the physical mockup (e.g. a cab of a vehicle). The screens have to be large enough to represent the full extent of the virtual environment being displayed so that a significant viewing angle is covered. Large curved projection screens have also been used. Non-projected, non-stereo systems are more widely used than projected, non-stereo systems, particularly in flight simulators and gaming systems. In this case, banks of CRT displays are used to display different viewing points, such as windowpanes in a cockpit.

Most 3D training environments today either make use of banks of monitors in which 3D images are displayed (as in flight simulator environments), or operators sit in front of a series of large screens on which high resolution images are projected. Such environments are suitable for activities where reactions to distant objects are required (such as flight simulators) but are generally unsuitable for operations requiring good depth of field and immersive presence. Such training environments provide poor depth perception for distances of 50 meters or less where it becomes most important. Multi-screen dodecahedron environments have been developed for flight simulators.

Stereo-based personal systems consist of a variation on 3D head mounted devices (3D HMD's). Typically images (models and simulations) are generated by a computer, which sends right and left eye images to small LCD or LYCOS-type screens worn over the eyes. Head and/or hands may be tracked using off-the-shelf components.

Alternatives available for projected immersive virtual reality systems involve locating an individual within a Computer Aided Visualization Environment (CAVE™) or CAVE-like environment, or alternatively wheeling the operating environment in which the operator sits into a CAVE-like environment. The CAVE™ is a room whose walls, ceiling and floor surround a viewer with projected images. The CAVE-like environment provides a full surrounding immersive environment. Viewing is accomplished through a set of “shutter glasses”. Since virtual reality is achieved through sequentially projecting right and left eye images, these glasses allow right and left eye viewing in synch with the projection.

In the market today, there are few options available for creating personal virtual reality environments for training applications that also provide immersion. The available options for immersive environments include Computer Aided Visualization Environments (CAVE™) and tracked 3D HMD's. CAVE™ environments require significant capital investment, large spaces (at least 45-50 m² floor space and a height of close to 4 meters), extensive computing capability, expensive projection systems and the operating environment must be placed within the CAVE™. CAVE™ environments are not typically used as training simulators. HMD's are low cost solutions but typically do not offer the resolution required. They lack the sense of realism due to the limited field of view and require wearing of tethered devices. The combination of these creates an uncomfortable use situation and many users can only operate for a matter of minutes in such environments.

U.S. Pat. No. 5,275,565 describes a simulator having multiple CRT monitors, which display images as would be seen from a cab of a vehicle. The images are not blended between monitors. This patent does not disclose the use of stereo images, there is no tracking of the operator position to adjust the image in relation to operator position, and the images are not projected from a projector. The system disclosed in this patent does not provide a very realistic simulation at high visual fidelity.

U.S. Pat. No. 6,146,143 and U.S. Pat. No. 6,361,321 both to Huston et al. describe a driving simulator, which simulates driving a vehicle in various weather conditions and traffic events. Simulations are displayed by video projectors controlled by a computer. There is no indication that the interstices between video projection screens are themselves incorporated into the simulation as elements of the simulated vehicle. Furthermore, there is no indication that stereo projection is desirable or can be achieved.

U.S. Pat. No. 6,152,739 describes a visual display system for a flight simulator having a plurality of video displays and a plurality of lenses for restricting the operators view in order to produce a far-focused continuous virtual image. It is a major aspect of this patent to produce a virtual image that does not have perceptual breaks between video displays, hence the use of a plurality of lenses. The invention described does not make use of the perceptual breaks between video displays by incorporating them into the overall environment.

U.S. Pat. No. 4,473,355 describes a screen in the form of a vault for a visual simulator for an airplane. The screen is back projected and is provided on the inside in each projection field with a Fresnel-type collecting lens having an optical axis pointing towards a cockpit. There is no teaching in this patent of using the interstices between screens as part of the overall simulated environment nor is there teaching of stereo projection.

U.S. Pat. No. 5,137,348 describes a projection system for a helicopter simulation which provides a large field of view in the vertical as well as horizontal field. The system employs spherical mirrors to project a display in the vertical field. The overall environment uses a separate physical cockpit and the screens are located outside the cockpit. There is no integration of the screens into the cockpit environment itself. Furthermore, there is no teaching of 3D-stereo projection.

U.S. Pat. No. 5,137,450 describes a flight simulator having pentagonal shaped back-projected screens joined along the edges to form a partial dodecahedron. The screens are placed less than 3.5 feet across an optically unmodified space (i.e. a putative cockpit). The patent teaches that there may be a 1 cm dark separation between screens which offers no distraction. In one embodiment, alternating images from different points of view may be projected on to the screens and special eyewear used to resolve one point of view. In this way, two crewmembers may sit in the same cockpit and see different points of view in relation to the position each occupies in the cockpit. There is no teaching of using the interstices between screens as part of the simulated environment and there is no teaching of using 3D-stereo projection.

World Patent publication WO 98/01841, U.S. Pat. No. 5,746,599, U.S. Pat. No. 5,927,985, and U.S. Pat. No. 6,190,172 describe a flight simulator comprising a plurality of display screens circumscribing an imaginary sphere. These documents do not teach integrating the interstices between screens into the simulated environment. In fact, at page 4, line 18-24 of the WO document, it is taught that the edges of the displays may comprise tabs so that the projected images may be clarified at these regions. Thus, there is an active effort not to use the interstices themselves as simulation elements.

Despite the obvious advantages of virtual reality simulation, simulators developed to date have been disappointing in their ability to render a low-cost versatile realistic virtual environment in which a trainee is immersed in the environment and feels as if he or she is in a real environment. As a result, the quality of training using simulators may not be as good as desired and the infrastructure needed for better simulators is expensive and not versatile. There is still a need in the art for a low-cost versatile virtual reality simulator that provides a high quality immersive virtual environment.

### SUMMARY OF THE INVENTION

The realistic visual environment is a combination of physical components and virtual components. The physical components of the realistic visual environment are collectively and generically termed the simulation space. The virtual components of the realistic visual environment are collectively and generically termed the 3D virtual views. In the present invention, the perceptual integration of a physical component with a virtual component to provide a realistic visual environment provides unexpected realism, thereby improving the effectiveness of the simulation. This is particularly useful for enhancing the ability of the simulation to impart the necessary real-life skills to an operator learning to operate real equipment. By integrating physical and virtual components in a manner described herein, the present invention places the same operating restrictions on a virtual operator as would be placed on a real operator in a real-life situation.

In an aspect of the present invention, there is provided a windowed immersive environment comprising: a frame delineating a simulation space for a realistic visual environment; a plurality of back-projection display screens mounted in the frame defining windows in the realistic visual environment, each display screen having a front facing inwardly and a back facing outwardly in the simulation space; a plurality of projectors for projecting pairs of offset images on to the back of the back-projection display screens, each display screen associated with at least one projector, each pair of offset images depicting a view out of one of the windows of the visual environment; means for resolving the offset images into 3D stereo images to represent 3D virtual views out of the windows of the realistic visual environment; and, one or more frame elements of the simulation space defining one or more non-windowed parts of the visual environment perceptually integrated with one or more of the 3D virtual views to provide the realistic visual environment.

In another aspect of the present invention, there is provided a method for simulating a realistic visual environment comprising: providing a frame delineating a simulation space, the frame having a plurality of back-projection display screens mounted therein defining windows in the realistic visual environment, each display screen having a front facing inwardly and a back facing outwardly in the simulation space, the frame having one or more frame elements defining one or more non-windowed parts of the realistic visual environment; projecting pairs of offset images on to the back of the back-projection display screens, each pair of offset images on each display screen depicting a view out of one of the windows of the realistic visual environment; and, resolving the offset images into 3D stereo images to represent 3D virtual views out of the windows, the 3D virtual views perceptually integrated with the one or more frame elements defining one or more non-windowed parts thereby providing the realistic visual environment.

As discussed above, CAVE™ or CAVE-like environments of the prior art require large virtual reality screens that are separate from an operating environment of a simulation. This results in perceptual decoupling of the virtual world from the operating environment. Thus, the physical and virtual components are not perceptually integrated. The present invention eliminates the need to have projection surfaces separate from the operating environment, thereby permitting a continuous immersive view of a virtual world (the 3D virtual views) appearing outside of a physical simulation space using a smaller, less expensive system. In the present invention, the operating environment becomes the viewing environment.

The environment of the present invention provides improved depth perception in all desired directions, improved peripheral vision, or a combination thereof. The present invention provides unparalleled realism through a low cost, highly versatile immersive reality environment having reduced space requirements. For example, the operating environment of the present invention in certain instances can occupy a floor space of less than 10 m², thereby providing up to an 80% reduction in floor space requirements, and a ceiling height of less than 2.5 m, thereby providing up to a 25% reduction in height requirement, in comparison to CAVE™ or CAVE-like environments. Environments of the present invention are significantly more realistic than those provided by any of the non-stereo or stereo-based personal system known in the art.

The present invention advantageously provides an effective immersive training environment that affords a high degree of visual fidelity and realistic depth of vision at appropriate distances at a reasonable cost. Surprisingly, a high degree of visual fidelity is achieved even with lower screen quality and projector resolution. Furthermore, since frame elements of the simulation space define one or more windowed parts of the visual environment perceptually integrated with one or more of the 3D virtual views, the requirements for controlling the images can be much less demanding resulting in reduced computer power requirements. There is no need to blend edges of the images into a seamless whole at the corners, as is required with prior art 3D stereo systems.

The present invention simulates a view that a user would see when looking out of a set of window or openings—an immersive “through windows view”. The present invention is adaptable to a variety of applications where there is a desire to simulate activities in a virtual world viewed through windows or other ports in vehicles or other enclosed environments. By using screens which define windows in a realistic visual environment as 3D stereo projection surfaces, the present invention can achieve a true virtual reality view of a world outside of the windows.

The present invention can be applied to any field requiring or desiring virtual reality simulation, especially immersive environments. Some fields are, for example, training simulators, education, entertainment, performance evaluation, personal gaming environments and remote control simulation. In particular, the present invention is useful for training operators of vehicles, for example, aircraft (e.g. airplanes, helicopters), motor vehicles (e.g. cars, trucks) and construction equipment (e.g. cranes).

The frame is a physical component and delineates the simulation space for the realistic visual environment. The frame may be constructed as a mockup, or it may be constructed from an existing real operating environment, for example the cab of a vehicle. Any suitable material can be used in the construction, e.g. wood plastic, metal. The size and shape of the frame will depend on the application. To enhance the realism of the simulation, the frame may be sized and shaped to the actual size and shape of the real operating environment being simulated. As indicated above, the present invention requires less space than prior art systems, therefore, the present invention offers great versatility in the size and shape of the frame used. The frame may also provide a structure on which other physical components may be mounted.

A plurality of back-projection display screens is mounted in the frame to define windows in the realistic visual environment. A window is any transparent portal through which an operator can look to perceive the world outside an operating environment. Windows in a real operating environment could be covered by a transparent medium, such as glass, or could be an uncovered opening. The screens are preferably placed where windows would normally be in the real operating environment. Each screen has a front and a back, the front facing inwardly in the simulation space and the back facing outwardly in the simulation space. The screens may be of any size and shape and may be oriented in any desired manner. It is preferable that the screens be of the same size and shape and oriented in the same manner as the windows in the real operating environment. Such versatility permits the use of smaller screens when desired (e.g. 4′×3′) as opposed to CAVE™ systems which require larger screens (e.g. at least 8′×6′). Additionally, such versatility provides no limit on the number and orientations of screens that may be used. In the present invention, each screen provides a separate view so the screens are easily reconfigurable. In contrast, CAVE™ systems are limited by the number of walls in the CAVE™, and each wall must integrate into the whole environment so orientation of the screens in respect of each other is critical.

The back-projection screens used may be of any desired type and quality. However, it is an advantage of the present invention that the screens can be of lower quality and cost while still providing a high degree of visual fidelity and realistic depth of vision at appropriate distances. Screens may be flexible or rigid, may have any desired viewing cone (e.g. 70° to 180°), may be of any desired screen ratio, and may have any desired light gain (e.g. 0.5 to 2.5). Some examples of screens include Da-Tex™, Dual Vision™, Da-Plex™ and Dai-Nippon™ (products from Da-Lite Screen Company Inc. of Indiana), and Cineflex™, Cinefold™, Cineperm™, DiamondScreen™ and IRUS (products from Draper company).

Projectors are used to project pairs of offset images on to the back of the screens so that each pair of offset images depicts a view out of one of the windows. Consequently, projectors must be placed so that they can project images on to the back of the screens. Projectors may be placed directly behind the screens, or, through the use of mirrors (as further described below) projectors may be placed almost anywhere in the simulation space. Any suitable projector may be used. However, it is an advantage of the present invention that the projectors can be of lower resolution and cost while still providing a high degree of visual fidelity and realistic depth of vision at appropriate distances. For example, the present invention may employ 84 Hz and up projectors at a resolution as low as 640×480 while projectors for CAVE™ systems are typically 96-120 Hz with a resolution of 2000×1024. In addition, the projectors used in the present invention need only project part of a virtual world, whereas projectors used in a CAVE™ system need to project a whole virtual world. Therefore, less expensive projectors may be used in the present invention. Examples of projectors useful in the present invention include, for example, a Seleco™ SDV100 or a Seleco™ SDV250 projector.

The pairs of offset images may be resolved into 3D stereo images by any suitable means. In this embodiment, an operator may wear a pair of stereo shutter glasses. The 3D stereo images seen on the screens by the operator represent 3D virtual views out of the windows of the realistic visual environment. One or more of the frame elements, or other physical components, defining one or more non-windowed parts of the visual environment are perceptually integrated with one or more of the 3D virtual views to provide the realistic visual environment. For example, the frame elements between two adjacent screens may be visually perceived as the window frame between two adjacent windows of the realistic visual environment. Therefore, it is unnecessary to virtually stitch together the two separate 3D virtual views out of adjacent windows since a physical component is acting as a perceptually integrated element of the visual environment to provide an illusion of continuity. The environment may be designed so that many or all of the physical components represent something in the realistic visual environment which are perceptually integrated with the 3D virtual views, thereby providing an exceedingly realistic simulation.

As indicated above, mirrors may be used in conjunction with projectors to project images on to the back of the screens. Mirrors permit versatility in the placement of the projectors permitting a reduction in the size of the simulation space and more efficient utilization of space. Mirrors may be mounted on the frame or within their own mounting units and may be pivotable or otherwise movable to assist with proper alignment. Single bounce or multiple bounce (e.g. double bounce) mirroring systems may be used. Single bounce systems result in less dimming while multiple bounce systems offer more versatility.

Regular or first surface mirrors may be used. Regular mirrors are cheaper, however, reflected light is dimmed by regular mirrors as well as associated light refraction issues. First surface mirrors, for example Mirrorlite™ from Hudson Photographic Industries, Inc., New York provide better light reflection but are more expensive. The size of the mirrors depends on the relationship between the width of the light cone produced by the projector, the distance from the projector to the screen, the angles and locations in which the mirrors have to be placed. One skilled in the art can readily determine the number of mirrors required and their sizes based on the projected light path within a particular simulation space. Flat mirrors are desirable where dimensional accuracy is required. Alignment of the mirrors is important and once alignment is achieved the mirrors should be fixed rigidly in place to avoid distortion or misalignment of the image on screen.

The simulation space may comprise other physical components to enhance realism of the simulation or to provide structural integrity or aesthetic effect to the simulation space. Some examples include light shielding, operator displays, operator controls, seats, doors, stairs, handrails, etc. In order to shield the visual environment against unwanted light, curtains, panels or other shrouding elements may be employed and/or physical components may be painted an unreflective color, e.g. black. Operator displays may take any suitable form, for example, consoles or dashboards with video displays, gauges, LED read-outs, etc. Operator controls may take any suitable form, for example, joysticks, buttons, levers, wheels, foot pedals, dials, etc. Seats, doors, stairs and handrails may be used when the real operating environment uses them or when necessary to provide comfort or safety to the operator.

Image projection and/or graphics may be controlled and/or coordinated using a graphics control computer system. Any suitable off-the-shelf system may be used, for example, an SGI Onyx 2, or a PC-based graphics cluster with 3D stereo capable graphic cards properly interlocked. An operator feedback system to handle operator feedback can be interfaced to the graphics control computer. The operator feedback system may be a separate personal computer equipped with accessories to interface with controls and displays or these may be incorporated in the graphics system itself. Feedback from the operator feedback computer may be used by the graphics control computer to adjust projected images and alter the 3D virtual views. The graphics control computer system may run off-the-shelf or specifically developed simulation software that produces desired images for the simulation; for example, flights simulators, heavy equipment simulators, driving simulators or control room simulators. Set-up parameters of the simulation software can be readily configured by one skilled in the art to meet hardware requirements of the particular computer systems and projectors used.

To further enhance realism of the simulation, the position and orientation of the operator may be tracked by a tracking system, and tracking information obtained therefrom is transmitted to the graphics control computer running the simulation software to adjust the projected images to correlate with the changed position and orientation of the operator. In this way, the 3D virtual views may be synchronized with the position and orientation of the operator thereby providing a more realistic simulation, as the environment observed through the windows is changed accordingly. Tracking may be accomplished by any suitable means, for example, by magnetic, ultrasound, inertial or optical trackers or a combination thereof. In this regard, the present invention is particularly advantageous as the necessary image adjustments are simpler to make in a system in which the views are separate, rather than in systems, such as CAVE™, in which the views are digitally blended into a whole world. When magnetic tracking is used, the simulation space should preferably not be constructed of ferrous material.

Further features of the invention will be described or will become apparent in the course of the following detailed description.

### BRIEF DESCRIPTION OF THE DRAWINGS

In order that the invention may be more clearly understood, embodiments thereof will now be described in detail by way of example, with reference to the accompanying drawings, in which:

FIG. 1 is a schematic illustration of an unshrouded simulation space representing a generic vehicle cab as a realistic visual environment of the present invention;

FIG. 2 is a schematic illustration of the inside of the cab represented in FIG. 1;

FIG. 3 is a schematic illustration depicting the orientation of the front mirror and front projector of the simulation space of FIG. 1;

FIG. 4 is a schematic illustration depicting the orientation of the top mirrors and top projector of the simulation space of FIG. 1;

FIGS. 5a and 5b are schematic illustrations depicting the orientation of the right side mirrors and right side projector of the simulation space of FIG. 1; and,

FIG. 6 is a schematic illustration of an unshrouded simulation space representing a crane cab as a realistic visual environment of the present invention.

### DESCRIPTION OF PREFERRED EMBODIMENTS

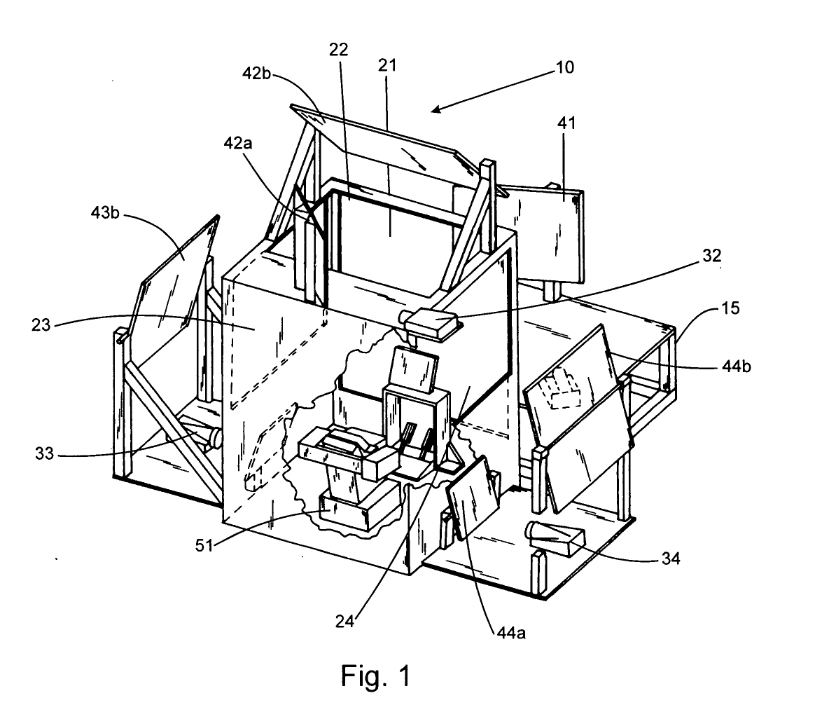

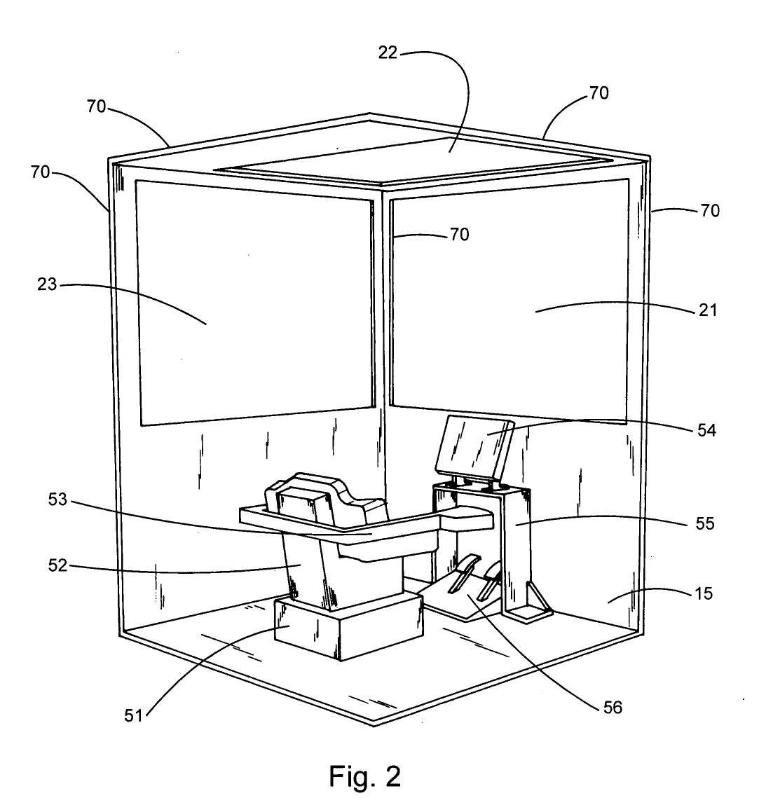

Referring to FIGS. 1 and 2, a generic vehicle cab may be simulated by providing a simulation space, generally shown unshrouded at 10, having a frame 15, four back-projection display screens including a front screen 21, a top screen 22, a left side screen 23 and a right side screen 24 respectively defining front, top, left side and right side windows of the vehicle cab, and four projectors including a front projector (not shown), a top projector 32, a left side projector 33 and a right side projector 34. Each of the screens is 48″×36″. Each of the four projectors projects a pair of off-set images on to the back of its corresponding screen, e.g. the front projector projects images on to the back of the front screen.

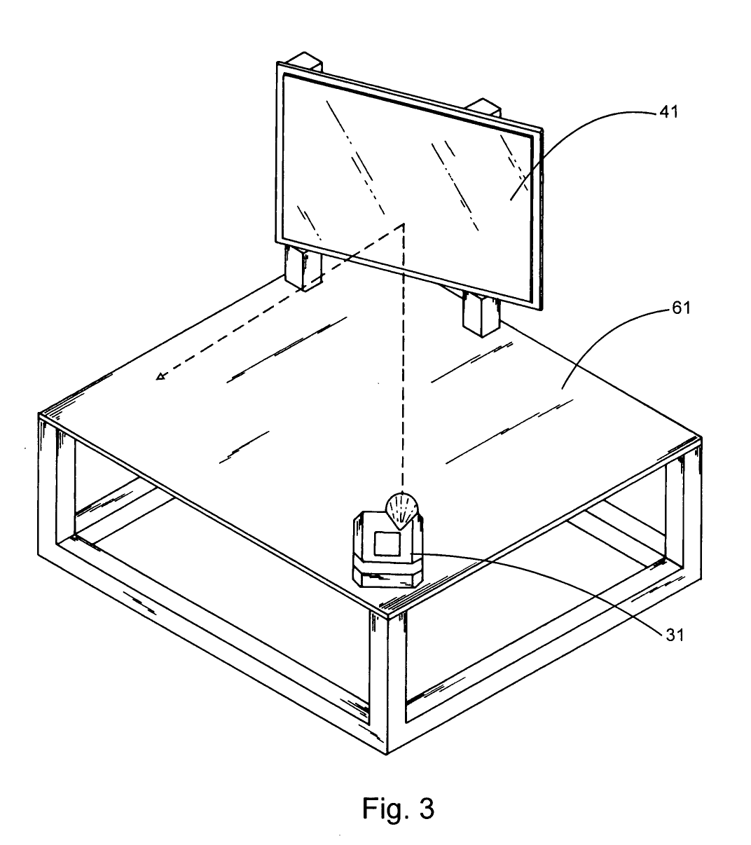

If the projectors were mounted directly behind the screens to project the images directly on to the back of the screens, the distance from the projector to the screen would be so large as to compromise overall compactness of the simulation space. By using mirrors between the projectors and the back of their corresponding screens, it is possible to provide a long projection path while having the projectors closer to the screens. In the present embodiment, a single front mirror 41 provides a single bounce projection path for the front. Two top mirrors 42a,42b provide a double bounce projection path for the top. Two left side mirrors 43b (the other not shown) provide a double bounce projection path the left side. And, two right side mirrors 44a,44b provide a double bounce projection path for the right side. Mirror placement and size are discussed below with reference to FIGS. 3-5.

Still referring to FIGS. 1 and 2, the inside of the cab is provided with a seat base 51 upon which a seat 52 is mounted. The seat and seat base are isolated from the rest of the frame so that movement of an operator does not affect other elements of the frame or other elements attached to the frame (e.g. the projectors). The seat may swivel on the seat base. The seat is provided with a joystick 53 for providing operator feedback to simulation software. In some instances, the seat may not be required as the operator my be working in a standing position. A touch screen 54 for displaying simulation data and for providing operator feedback to the simulation software is mounted on a touch screen stand 55 located in front of the seat. Pedals 56 may also be used to provide operator feedback to the simulation software.

In use, the simulation space 10 is shrouded by heavy black draperies supported on the frame 15. Shrouding reduces stray light in the simulation space. The frame is constructed from wood studs and plywood and is painted flat black to reduce stray light in the simulation space.

Referring to FIG. 3, the front projector 31 is mounted in a corner of a front projection stand 61 adjacent, behind and at the right of the front screen. The front mirror 41, which is 32″ wide×24″ high, is mounted on the front projection stand at a corner diagonally opposite from the front projector and is angled to reflect projected images to the back of the front screen. The projection path from the front projector to the back of the front screen is shown in dashed line.

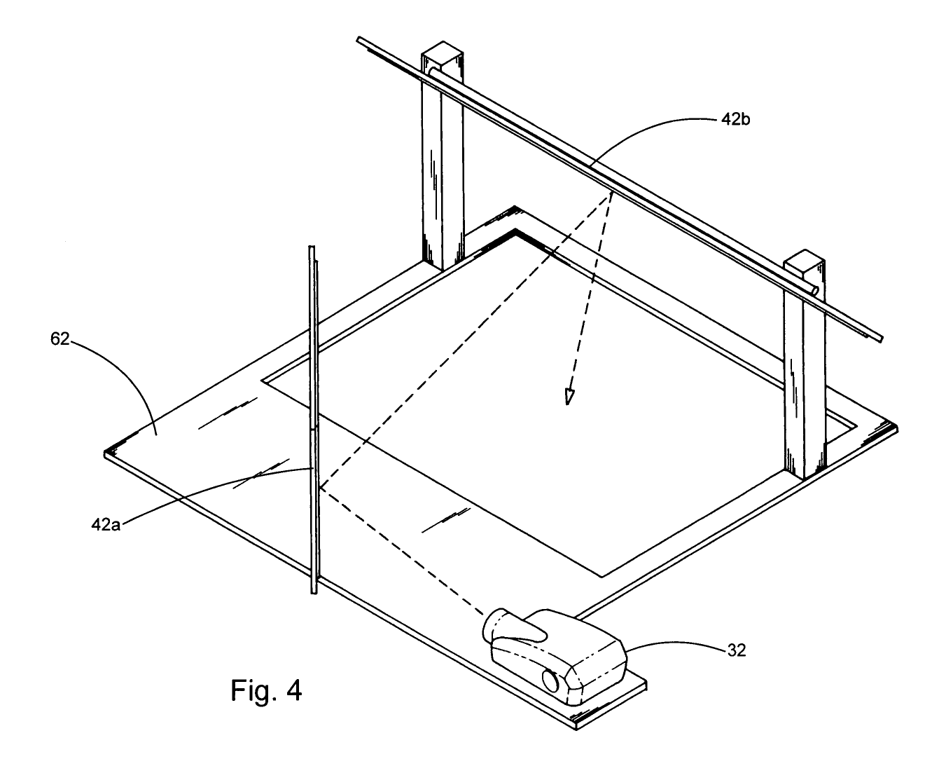

Referring to FIG. 4, the top projector 32 is mounted in a corner of the roof 62 of the cab. The top screen 22 is mounted in the roof of the cab and, as indicated previously, defines the top window. The small top mirror 42a and the large top mirror 42b are mounted on the roof and are angled to provide a double bounce projection path (shown in dashed line) from the top projector to the back of the top screen.

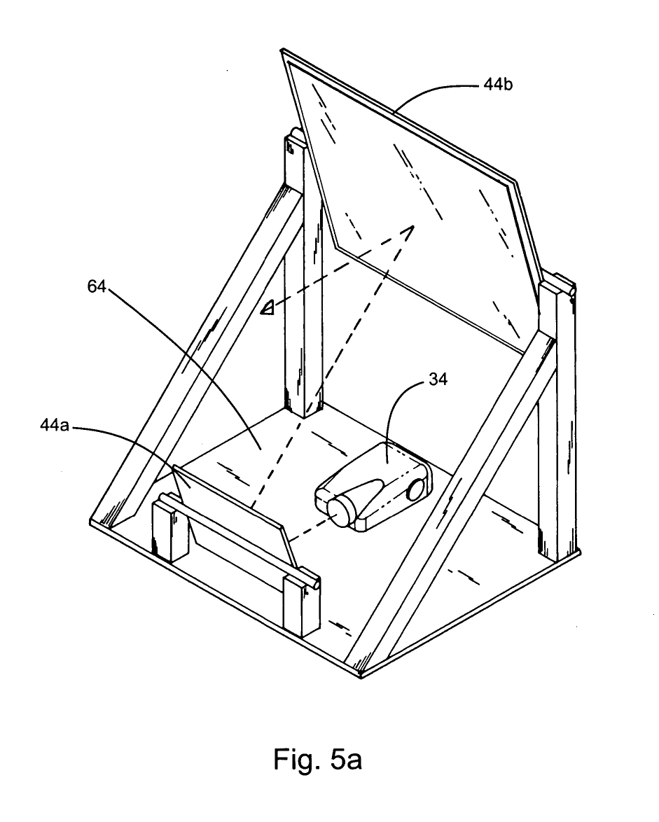

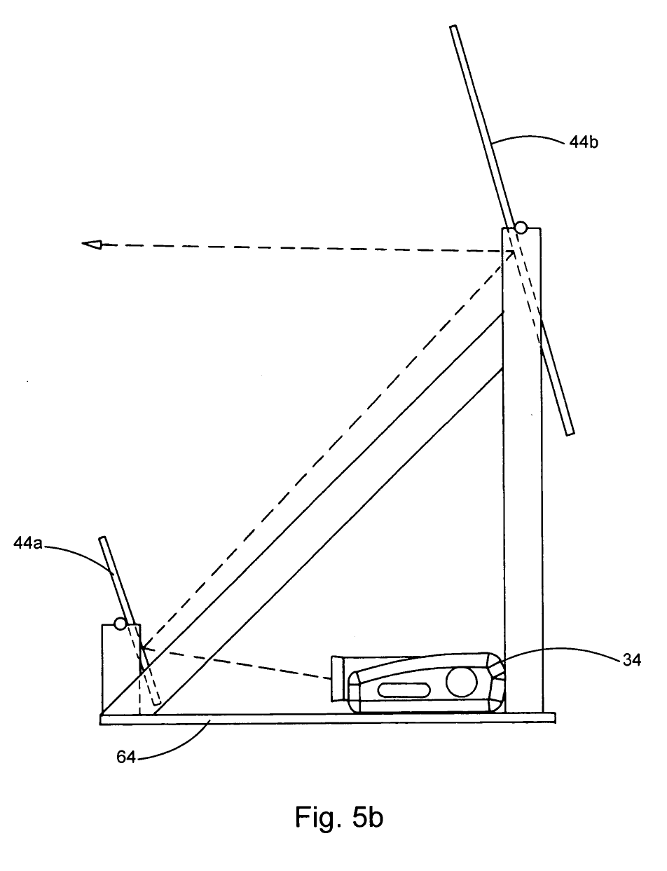

Referring to FIGS. 5a and 5b, the right side projector 34 is mounted at the center of one edge of a right side projection stand 64 on an edge farthest away from the right side screen. The small right side mirror 44a is mounted directly in front of the right side projector and the large right side mirror 44b is mounted above the right side projector. The two mirrors are angled to provide a double bounce projection path from the right side projector to the back of the right side screen. The left side is set up in a similar manner as the right side in order to provide a double bounce projection path from the left side projector to the back of the left side screen.

Referring to FIGS. 1 and 2, each of the screens 21,22,23,24 defines a window in the vehicle cab. On to the back of each screen, each projector 31,32,33,34 projects a pair of offset images. The offset images are resolved into 3D stereo images by means of stereo shutter glasses worn by the operator. The 3D stereo images represent 3D virtual views as seen out the windows of the cab.

The screens 21,22,23,24 are mounted in the frame 15 such that frame elements 70 around the screens represent window frames of the cab. The 3D virtual views are visually integrated with the frame elements 70 to provide an operator with a highly realistic illusion of being within the cab of the vehicle. Thus, when an operator looks out a window of the cab (i.e. looks at a screen), he or she sees the world depicted outside the window and perceives the frame elements around the screens as part of the window structure. The physical structure of the simulation space and the images of the 3D virtual views are visually a single environment in which the operator is immersed. Visually, there is little distinction between the physical and virtual worlds. In this way, a much more realistic environment is provided than is possible with prior art systems.

Projected images are generated by simulation software operated on an SGI Onyx 2 IR2 Deskside computer system (not shown). The images are generated using VRCO's CaveLib software modified to take into account the close proximity of the operator to the screen surfaces as well as to provide a through the window view of the virtual world. Operator feedback through the joystick, touch screen and foot pedals is controlled by a Pentium III personal computer (not shown) operating on a Linux platform. Position and orientation of the operator is tracked by an Ascension Flock of Birds (not shown) and position and orientation information is transmitted to the Onyx computer through a cable connection. Feedback from the joysticks is collected by the personal computer and sent to the Onyx system. This information is used to adjust and correlate the projected images appropriately.

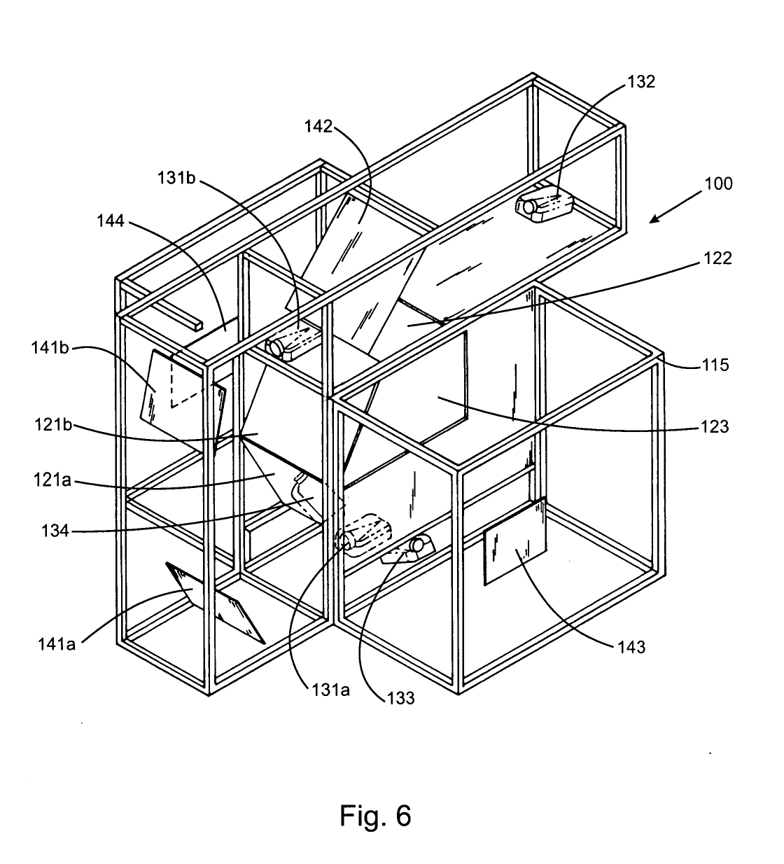

Referring to FIG. 6, a schematic illustration of a simulation space representing a cab of a crane is shown. In this configuration, a simulation space, generally shown unshrouded at 100, has a frame 115, five back-projection display screens including a lower front screen 121a, an upper front screen 121b, a top screen 122, a left side screen 123 and a right side screen (not labeled) respectively defining lower front, upper front, top, left side and right side windows of the crane cab, and five projectors including a lower front projector 131a, an upper front projector 131b, a top projector 132, a left side projector 133 and a right side projector 134. Each of the five projectors projects a pair of offset images on to the back of its corresponding screen. Projection paths for each of the five projectors are single bounce paths employing a single mirror 141a,141b,142,143,144 for each path. Other features of the simulation space, for example the tracking feature, shrouding, computer systems, etc. are similar to those described above for the generic vehicle cab. To generate 3D virtual views, custom crane simulation software is run on an SGI Onyx 2 IR2 Deskside computer system.

The crane cab of FIG. 6 is constructed to replicate the shape and size of an actual crane cab. The screens are sized and shaped to mimic the size and shape of the windows of an actual cab and are mounted in the frame in the same place that an actual window would be mounted in the actual cab frame of an actual crane cab. All of the other elements of the cab, for example, control levers, seats, display panels, etc. are also constructed to exactly replicate the inside of an actual crane cab. In this manner, an exact physical replica of the crane cab is simulated with all of the physical components of the cab visually integrated with the 3D virtual views seen through the windows. The 3D virtual views are produced by resolving pairs of offset images projected on the back of the screens into stereo images.

Other advantages that are inherent to the structure are obvious to one skilled in the art. The embodiments are described herein illustratively and are not meant to limit the scope of the invention as claimed. Variations of the foregoing embodiments will be evident to a person of ordinary skill and are intended by the inventor to be encompassed by the following claims.

1. A windowed immersive environment comprising:
(a) a frame delineating a simulation space for a realistic visual environment;
(b) a plurality of back-projection display screens mounted in the frame defining windows in the realistic visual environment, each display screen having a front facing inwardly and a back facing outwardly in the simulation space;
(c) a plurality of projectors for projecting pairs of offset images on to the back of the back-projection display screens, each display screen associated with at least one projector, each pair of offset images depicting a view out of one of the windows of the visual environment;
(d) means for resolving the offset images into 3D stereo images to represent 3D virtual views out of the windows of the realistic visual environment; and,
(e) one or more frame elements of the simulation space defining one or more non-windowed parts of the visual environment perceptually integrated with one or more of the 3D virtual views to provide the realistic visual environment.

2. The windowed immersive environment of claim 1, further comprising a tracking system for tracking position and orientation of an operator.

3. The windowed immersive environment of claim 1, further comprising a graphics control computer system for controlling and/or coordinating image projection and/or graphics.

4. The windowed immersive environment of claim 3, further comprising simulation software for producing images.

5. The windowed immersive environment of claim 1, wherein the means for resolving the offset images into 3D stereo images is a pair of shutter glasses.

6. The windowed immersive environment of claim 1, further comprising an operator feedback system.

7. The windowed immersive environment of claim 1, further comprising light shielding to reduce unwanted light in the visual environment.

8. The windowed immersive environment of claim 1, wherein the realistic visual environment is a vehicle cab having views outside windows of the cab.

9. The windowed immersive environment of claim 8, wherein one or more of the non-windowed parts defined by the frame elements is a window frame between adjacent windows of the cab.

10. The windowed immersive environment of claim 1, wherein the one or more frame elements of the simulation space defining one or more non-windowed parts of the visual environment are visually integrated with one or more of the 3D virtual views.

11. A method for simulating a realistic visual environment comprising:
(a) providing a frame delineating a simulation space, the frame having a plurality of back-projection display screens mounted therein defining windows in the realistic visual environment, each display screen having a front facing inwardly and a back facing outwardly in the simulation space, the frame having one or more frame elements defining one or more non-windowed parts of the realistic visual environment;
(b) projecting pairs of offset images on to the back of the back-projection display screens, each pair of offset images on each display screen depicting a view out of one of the windows of the realistic visual environment; and,
(c) resolving the offset images into 3D stereo images to represent 3D virtual views out of the windows, the 3D virtual views perceptually integrated with the one or more frame elements defining one or more non-windowed parts thereby providing the realistic visual environment.

12. The method of claim 11, wherein the 3D virtual views are visually integrated with the one or more frame elements.

13. The method of claim 12, further comprising tracking position and/or orientation of an operator to provide position and/or orientation information, and adjusting the 3D virtual views to correlate with the position and/or orientation of the operator.

14. The method of claim 12, further comprising adjusting the 3D virtual views in response to operator feedback.

15. The method of claim 12, wherein the realistic visual environment is a vehicle cab having views outside windows of the cab.
